(19) United States
(12) Patent Application Publication
(10) Pub. No.: US 2009/0199166 A1
(43) Pub. Date: Aug. 6, 2009

(54) PROGRAM CONVERTING DEVICE

(76) Inventor: Toshiyuki SAKATA, Osaka (JP)

Correspondence Address: MCDERMOTT WILL & EMERY LLP, 600 13TH STREET, NW, WASHINGTON, DC, 20005-3096, US

(21) Appl. No.: 12/349,817

(22) Filed: Jan. 7, 2009

(30) Foreign Application Priority Data
Feb. 1, 2008 (JP) 2008-022884

(51) Int. Cl. G06F 9/45

(52) U.S. Cl. 717/136

(57) ABSTRACT

In a program converting device, an initial-value-of-variable recognizing unit recognizes variables and initial values of the variables included in a source program. A place-of-variable determining unit, when the recognized variables are variables having a large number of specific values of the initial values, determines that the variables are to be placed in specific value areas that are each initialized with the specific value before execution of a program. An specific-value-area variable placing unit places variables having a large number of specific values of the initial values in the specific value area, and further, when the initial values of the variables include a value other than the specific value, generates an initialization code for the value other than the specific value.

### CROSS REFERENCE TO RELATED APPLICATIONS

This Non-provisional application claims priority under 35 U.S.C. §119(a) on Patent Application No. 2008-022884 filed in Japan on Feb. 1, 2008, the entire contents of which are hereby incorporated by reference.

### BACKGROUND OF THE INVENTION

1. Field of the Invention

The present invention relates to a program converting device for converting an input source program into an object program and outputting the object program. More particularly, the present invention relates to a process of determining in what area of a memory a variable having an initial value is placed.

2. Description of the Related Art

In conventional program converting devices, when variables included in an input source program have initial values, these initial values are output as a part of an executable program, i.e., the initial values are included, in the executable program, as data with which a variable area in a RAM is initialized during the start of execution of the executable program. Therefore, when a large number of variables having the same initial value are described in a source program, the code size of the executable program is disadvantageously large.

To solve the problem, for example, Patent Document 1 (Japanese Patent No. 3214608) discloses a method in which initialization data is not used during initialization, and instead, initialization codes are used. In the method, when a large number of consecutive variable definitions have the same initial value, codes that initialize the whole area with the same initial value are first generated, and thereafter, codes that initialize a different portion are generated.

Patent Document 2 (Japanese Unexamined Patent Application Publication No. 2004-280311) discloses a method in which variables having a specific initial value are analyzed, and the variables are placed in an area that is initialized with the specific value during execution.

However, when the method of Patent Document 1 is applied to variables to which an area is allocated in a memory, optimization of a place where the variables are placed, depending on values of initial value data, is not performed. Therefore, this method is not satisfactorily effective to a source program in which a variable definition that has a specific initial value and a variable definition that does not have a specific initial value alternately appear. Also, since variables having a specific initial value are not all placed in a single area, the amount of codes for initialization with a specific code is disadvantageously increased as compared to a method in which variables having a specific initial value are all placed in a single area. FIG. 13 shows a conceptual diagram of an exemplary result of conversion where a source program shown in FIG. 7 is input and is then converted using the method of Patent Document 1.

On the other hand, in the method of Patent Document 2, variables to be initialized with a specific value are all initialized into a single area. Therefore, the method is considerably effective when variables having only a specific initial value are initialized, and the code size of an executable program can be reduced as compared to the method of Patent Document 1. However, the method of Patent Document 2 cannot be applied to a variable, such as an array, a structure or the like, having initial values a part of which includes a value other than a specific value. FIG. 14 shows a conceptual diagram of an exemplary result of conversion where the source program of FIG. 7 is input and is then converted using the method of Patent Document 2.

### SUMMARY OF THE INVENTION

An object of the present disclosure is to provide a program converting device in which, even when a large number of variables having a large number of the same initial values are included in a source program, the code size of its executable program is effectively reduced as compared to the conventional art.

To achieve the object, in this disclosure, variables having a large number of specific initial values are also placed in an area that is initialized with the specific value during execution, and initialization codes are generated for an initial value other than the specific value.

Specifically, a program converting device according to the present disclosure is provided for converting an input source program to output an object program. The device includes a recognition unit for recognizing variables and initial values of the variables included in the source program, and a specific-value-area variable placing unit for placing the variables recognized by the recognition unit in specific value areas that are each initialized with a specific value before execution of the program, and when a value other than the specific value is included in the initial values of the variables, generating an initialization code with respect to the initial value other than the specific value.

In an embodiment of the program converting device, the program converting device further includes a place determining unit for calculating a cost when each of the variables recognized by the recognition unit is placed in a data area that is initialized with initialization data, and a cost when the each of the variables recognized by the recognition unit is placed in a specific value area that is initialized with a specific value, and depending on a result of the calculation, determining whether the each of the variables is to be placed in the data area or the specific value area.

In an embodiment of the program converting device, the cost is a code size.

In an embodiment of the program converting device, the cost is an execution time required to initialize the variables.

In an embodiment of the program converting device, the program converting device further includes a reception unit for receiving a user's designation about whether or not a variable including a value other than the specific value is to be placed in the specific value area.

In an embodiment of the program converting device, the specific value is 0.

In an embodiment of the program converting device, the program converting device further includes an initial-value-of-variable calculating unit for calculating an initial value of a variable when the initial value of the variable is not an immediate.

Thus, according to the present disclosure, a variable including a large number of specific initial values is placed in an area that is initialized with the specific value during execution, and initialization codes are generated for initial values other than the specific value. Thereby, a cost for initialization of the variable including a large number of specific initial values can be reduced.

In particular, in an embodiment of the present disclosure, it can be automatically determined whether a variable is to be placed in a data area or a specific value area. Therefore, an object file having an optimal data placement that minimizes the cost can be obtained without a designation by the programmer.

Also, in an embodiment of the present disclosure, an object file having data placement that minimizes the code size can be obtained.

Moreover, in an embodiment of the present disclosure, an object file having data placement that minimizes an execution time required to initialize a variable can be obtained.

In addition, in an embodiment of the present disclosure, the programmer can designate whether a variable is to be placed in a data area or a specific value area. Therefore, an object file having placement of a variable that is desired by the programmer can be obtained.

Also, in an embodiment of the present disclosure, a specific value area can be caused to correspond to the .bss section of the Executable and Linkable Format (ELF), which is an industrial standard object format, so that a generated object can be caused to conform to the industrial standard format. Note that the .bss section is a section in which data is initialized with 0 before the start of execution of a program, and which is defined, in the ELF, as a section that does not have an area in an object file.

Moreover, in an embodiment of the present disclosure, it is also possible to reduce a code size for initialization, with respect to a variable whose initialization is performed using an initialization function (constructor) described in the C++ language or the like.

### BRIEF DESCRIPTION OF THE DRAWINGS

FIG. 1 is a diagram showing a configuration of a program converting device according to an embodiment.

FIG. 2 is a flowchart showing an operation of a place-of-variable determining unit included in the program converting device.

FIG. 3 is a flowchart showing another exemplary operation of the place-of-variable determining unit.

FIG. 4 is a flowchart showing still another exemplary operation of the place-of-variable determining unit.

FIG. 5 is a flowchart showing even still another exemplary operation of the place-of-variable determining unit.

FIG. 6 is a flowchart showing an operation of a specific-value-of-variable placing unit included in the program converting device.

FIG. 7 is a diagram showing an exemplary source program.

FIG. 8 is a conceptual diagram showing an object program as a result of converting the source program of FIG. 7 by the program converting device of the embodiment.

FIG. 9 is a diagram showing another exemplary source program.

FIG. 10 is a conceptual diagram showing an object program as a result of converting the source program of FIG. 9 by the program converting device of the embodiment.

FIG. 11 is a diagram showing still another exemplary source program.

FIG. 12 is a conceptual diagram showing an object program as a result of converting the source program of FIG. 11 by the program converting device of the embodiment.

FIG. 13 is a conceptual diagram showing an object program as a result of converting the source program of FIG. 7 by a conventional program converting device.

FIG. 14 is a conceptual diagram showing an object program as a result of converting the source program of FIG. 7 by another conventional program converting device.

### DETAILED DESCRIPTION OF THE PREFERRED EMBODIMENTS

Hereinafter, embodiments of a program converting device of the present disclosure will be described with reference to the accompanying drawings.

(Configuration)

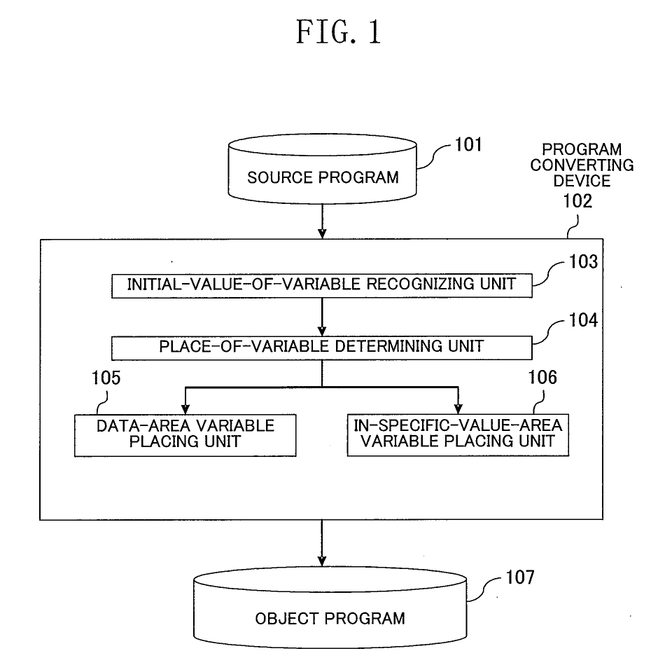

FIG. 1 is a diagram showing a configuration of a program converting device according to this embodiment. FIG. 1 shows, for the sake of convenience, a source program 101 that is input to a program converting device 102, and an object program 107 that is output from the program converting device 102. The program converting device 102 is a so-called compiler that is caused to convert the input source program 101 into the object program 107 by a CPU executing a program stored in a memory provided in a computer. The program converting device 102 comprises an initial-value-of-variable recognizing unit 103, a place-of-variable determining unit 104, a data-area variable placing unit 105, and a specific-value-area variable placing unit 106 so as to convert definitions of variables in a source program.

The initial-value-of-variable recognizing unit (recognition unit) 103 recognizes a variable to which an area is to be allocated in a memory (e.g., an external variable and a static variable in the C language) of variables included in the input source program 101, and its initial values.

The place-of-variable determining unit (place determining unit) 104 determines whether a variable is to be placed in a data area or a specific value area, based on the initial values of the variable recognized by the initial-value-of-variable recognizing unit 103.

The data-area variable placing unit 105, when the place-of-variable determining unit 104 determines that a variable is to be placed in a data area, places the variable in the data area, and generates initial value data that is to be copied to the area. The specific-value-area variable placing unit 106, when the place-of-variable determining unit 104 determines that a variable is to be placed in a specific value area, places the variable in the specific value area, and when a value other than the specific value is included in the initial values of the variable, generates initialization codes for that value.

Note that components other than those described above of the program converting device 102 (e.g., a syntax analyzer, an intermediate code optimizer, a register allocator, etc.) are the same as those used in a general program converting device and will not be herein described.

(Operation)

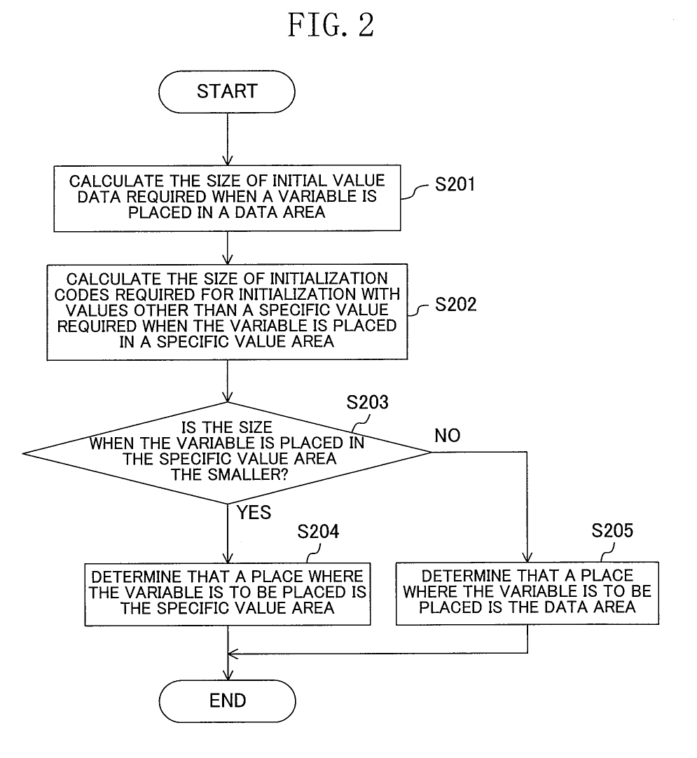

Next, an operation of the aforementioned place-of-variable determining unit 104 will be described with reference to a flowchart shown in FIG. 2.

Initially, the place-of-variable determining unit 104 calculates the size of initial value data that is required when a variable for which a place is to be determined is placed in a data area (step S201). Here, the size of the initial value data is equal to the size of the variable, i.e., if the variable size is x bytes, the initial value data size is x bytes. Next, the place-of-variable determining unit 104 calculates the size of initialization codes that are required for initialization with values other than a specific value that is required when the variable is placed in a specific value area (step S202). For example, when the size of codes for storing an immediate in a memory is n bytes and the number of values other than a specific value included in the initial values of the variable is y, the total size of initialization codes is n*y bytes. Next, the place-of-variable determining unit 104 compares the size when the variable is placed in the data area with the size when the variable is placed in the specific value area (step S203). When the size when the variable is placed in the specific value area is the smaller, the place-of-variable determining unit 104 determines that the variable is to be placed in the specific value area (step S204). When otherwise, the place-of-variable determining unit 104 determines that variable is to be placed in the data area (step S205).

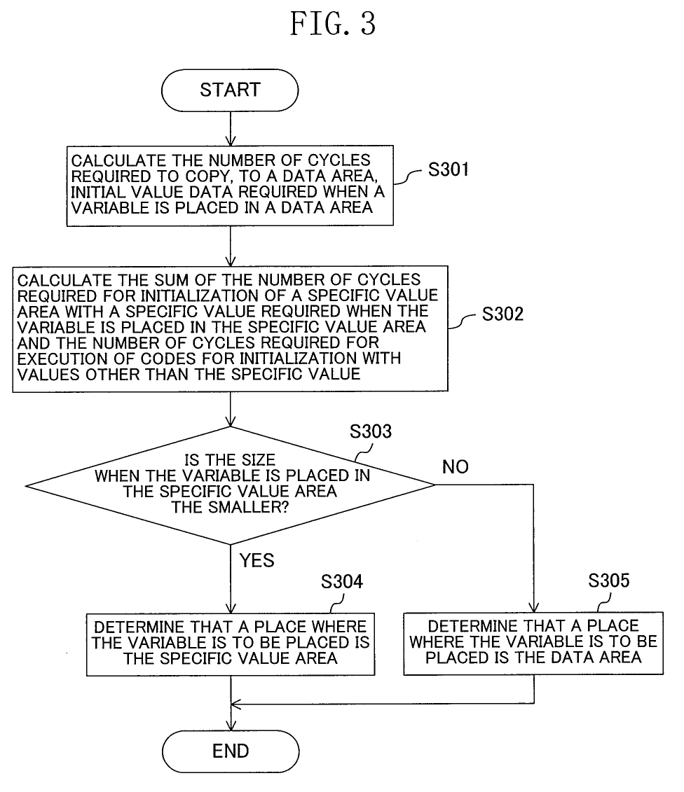

Note that it has been described in the flowchart of FIG. 2 that attention is paid to a code size and placement that reduces the code size is selected. Alternatively, instead of the code size, placement that reduces the number of execution cycles required for initialization during execution of a program, i.e., an execution time, may be selected. FIG. 3 shows a flowchart of an operation of the place-of-variable determining unit 104 in which attention is paid to the number of execution cycles.

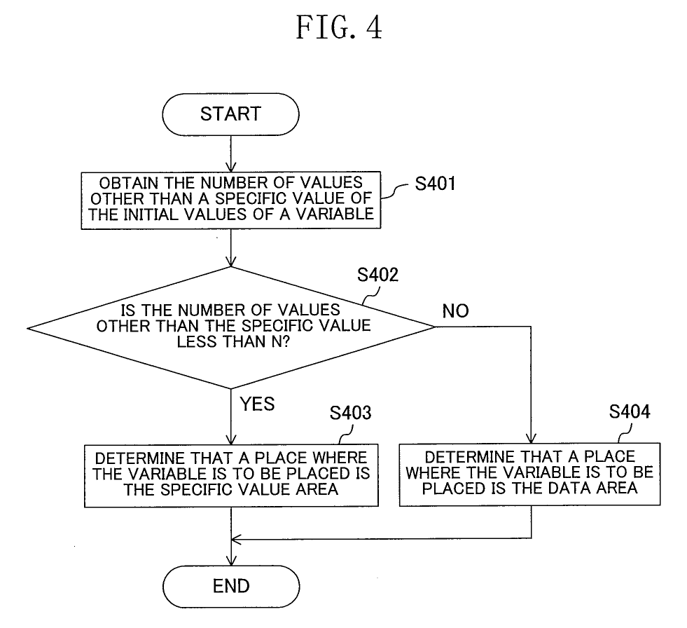

To determine whether a variable is to be placed in a data area or a specific value area, the number of values other than a specific value included in the initial values of the variable may be used. FIG. 4 shows a flowchart of an operation of the place-of-variable determining unit 104 when attention is paid to the number of values other than a specific value included in the initial values of a variable.

Moreover, an option given to the program converting device may be used to determine whether a place where a variable is to be placed is determined based on the code size or the number of execution cycles. For example, when an option is given in which optimization is performed while the code size is given priority, the place where a variable is to be placed may be determined in accordance with the flowchart of FIG. 2. When an option is given in which optimization is performed while the execution speed is given priority, the place where a variable is to be placed may be determined in accordance with the flowchart of FIG. 3.

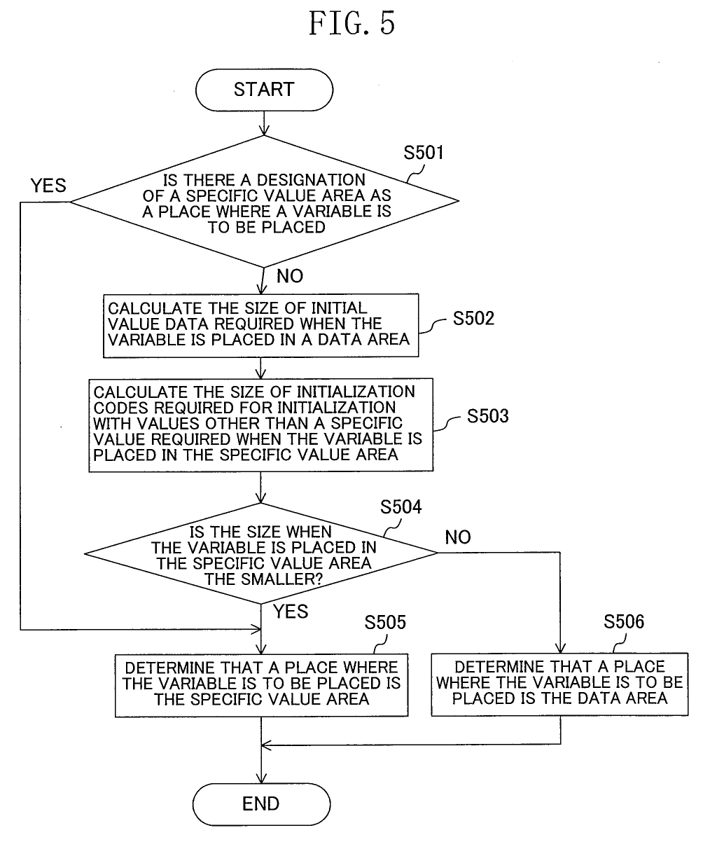

In addition, when a designation of a specific value area as a place where a specific variable is to be placed is described in a source program or is defined by an option, the specific variable may be unconditionally placed in the specific value area, and when otherwise, a place where a variable is to be placed may be determined based on the code size. FIG. 5 shows a flowchart of an operation of the place-of-variable determining unit 104 when this determination method is selected.

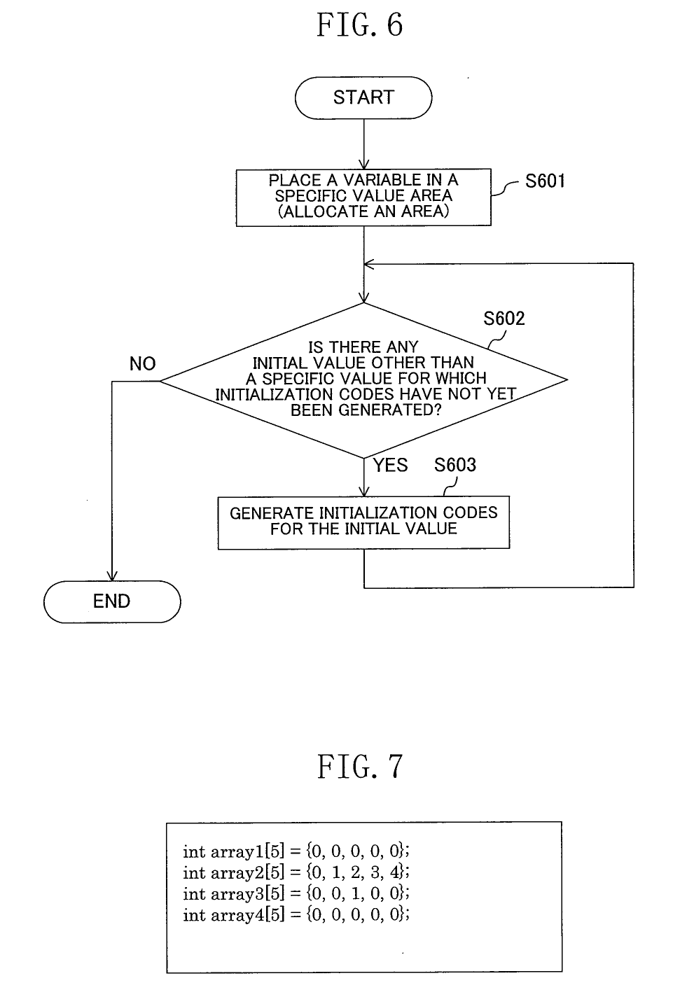

Next, an operation of the specific-value-area variable placing unit 106 will be described with reference to a flowchart of FIG. 6.

Initially, a variable is placed in a specific value area (step S601). Specifically, an area corresponding to the size of the variable is allocated in the specific value area. Next, it is determined whether or not there is any initial value of the variable that is other than a specific value and for which initialization codes have not yet been generated (step S602). When there is such an initial value, initialization codes for the initial value are generated (step S603), and the flow goes back to the process of step S602. When there is not such an initial value, the process of the specific-value-area variable placing unit 106 with respect to the variable is ended.

The operations of the initial-value-of-variable recognizing unit 103 and the data-area variable placing unit 105 are the same as the operations of those that are used in a general program converting device and will not be herein described.

(Specific Examples)

Hereinafter, specific operations of the place-of-variable determining unit 104 and the specific-value-area variable placing unit 106 of this embodiment will be described, assuming that the source program of FIG. 7 is input, for example.

It is here assumed that a specific value is 0 and the size of type “int” (integer) is 4 bytes. It is also assumed that the size of codes that are required to store an immediate in a memory is 8 bytes.

Firstly, a process of the place-of-variable determining unit 104 that determines a place where a variable array1 is to be placed will be described. Initially, a size when the variable array1 is placed in a data area is calculated (step S201). Here, array1 is an int-type array the number of elements of which is 5, so that the size when the variable array1 is placed in the data area is 20 bytes (=4 bytes*5). Next, a size when array1 is placed in a specific value area is calculated (step S202). Here, array1 has no initial value other than 0, so that the size when array1 is placed in the specific value area is 0 bytes (=8 bytes*0). Next, the size when array1 is placed in the data area is compared with the size when array1 is placed in the specific value area (step S203). Here, since the size when array1 is placed in the specific value area is the smaller, the place where array 1 is to be placed is determined to be the specific value area (step S204).

Next, a process of the place-of-variable determining unit 104 that determines a place where a variable array2 is to be placed will be described. Initially, a size when the variable array2 is placed in the data area is calculated (step S201). Here, array2 is an int-type array the number of elements of which is 5, so that the size when the variable array2 is placed in the data area is 20 bytes (=4 bytes*5). Next, a size when array2 is placed in the specific value area is calculated (step S202). Here, array2 has some initial values other than 0 the number of which is 4, so that the size when array2 is placed in the specific value area is 32 bytes (=8 bytes*4). Next, the size when array2 is placed in the data area is compared with the size when array2 is placed in the specific value area (step S203). Here, since the size when array2 is placed in the specific value area is the larger, the place where array 2 is to be placed is determined to be the data area (step S205).

Next, a process of the place-of-variable determining unit 104 that determines a place where a variable array3 is to be placed will be described. Initially, a size when the variable array3 is placed in the data area is calculated (step S201). Here, array3 is an int-type array the number of elements of which is 5, so that the size when the variable array3 is placed in the data area is 20 bytes (=4 bytes*5). Next, a size when array3 is placed in the specific value area is calculated (step S202). Here, array3 has a single initial value other than 0, so that the size when array3 is placed in the specific value area is 8 bytes (=8 bytes*1). Next, the size when array3 is placed in the data area is compared with the size when array3 is placed in the specific value area (step S203). Here, since the size when array3 is placed in the specific value area is the smaller, the place where array 3 is to be placed is determined to be the specific value area (step S204).

A variable array4 will not be described, since array4 has the same initial values as those of array1.

Next, a process of the specific-value-area variable placing unit 106 with respect to the variable array1 will be described. Initially, in order to place the variable array1 in the specific value area, an area of 20 bytes (the size of the variable array1) is allocated in the specific value area (step S601). Note that this area is actually allocated in a RAM during execution of a program and is not included in the size of an object program. The same is true of the data area. When the variable array1 is placed in the data area, initial value data of variables to be copied to the data area of the RAM during execution of a program is additionally required. The initial value data is included in the size of the object program. Next, it is determined whether or not there is any initial value other than the specific value for which initialization codes have not yet been generated (step S602). Here, all the initial values of array1 are 0, i.e., there is not such an initial value, so that the specific-value-area variable placing unit 106 ends the process with respect to the variable array1.

Next, a process of the specific-value-area variable placing unit 106 with respect to the variable array3 will be described. Initially, in order to place the variable array3 in the specific value area, an area of 20 bytes (the size of the variable array3) is allocated in the specific value area (step S601). Next, it is determined whether or not there is any initial value other than the specific value for which initialization codes have not yet been generated (step S602). Here, an initial value of 1 of array3[2] is found as an non-0 initial value in array3, so that initialization codes corresponding to “array3[2]=1” are generated (step S603). Next, it is determined whether or not there is any initial value other than the specific value for which initialization codes have not yet been generated (step S602). There is not such an initial value, so that the specific-value-area variable placing unit 106 ends the process with respect to the variable array3.

A process with respect to the variable array4 is similar to the process with respect to the variable array1 and will not be described.

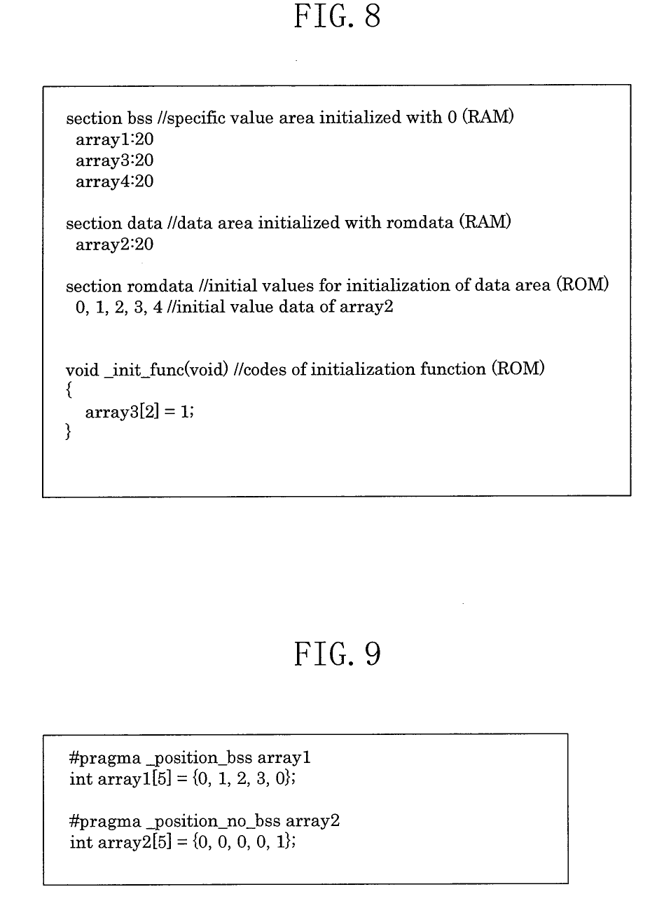

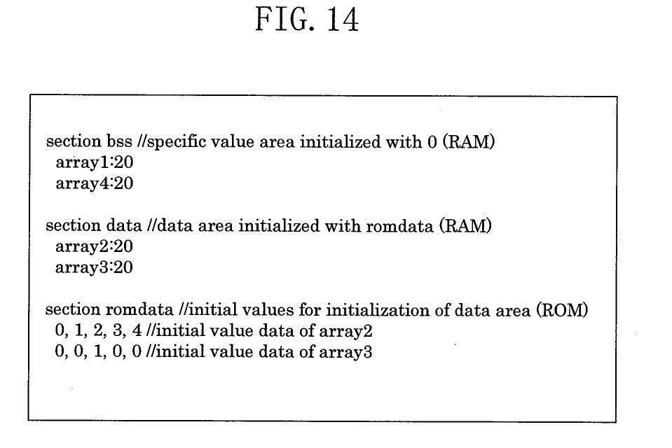

A conceptual diagram of an object file generated as a result from the aforementioned process is shown in FIG. 8. The variable array3 is placed in the specific value area, and initialization codes are generated with respect to the initial value other than the specific value. Therefore, the code size is reduced as compared to when array3 is placed in the data area (FIG. 14). Here, initialization codes are generated in the form of an initialization function that is executed before execution of a program. The initialization codes correspond to a function “_init_func” shown in FIG. 8. Although the initialization codes are described in the form of a function definition of the C language in FIG. 8 for the sake of easy understanding, machine instruction codes converted from the initialization codes are actually stored in an object file. Note that codes of an initialization function are generated by a method that is commonly used as a method for achieving dynamic initialization of a variable in the C++ language.

As described above, according to this embodiment, for a variable including a large number of specific values of the initial values, not all of the initial values need to be included as data in an executable program. Therefore, the code size of the executable program can be reduced.

Although the program converting device of this disclosure has been described based on the embodiment, the present invention is not limited to the embodiment. Specifically, for example, the following variations and modifications can be made without departing the scope of the present invention.

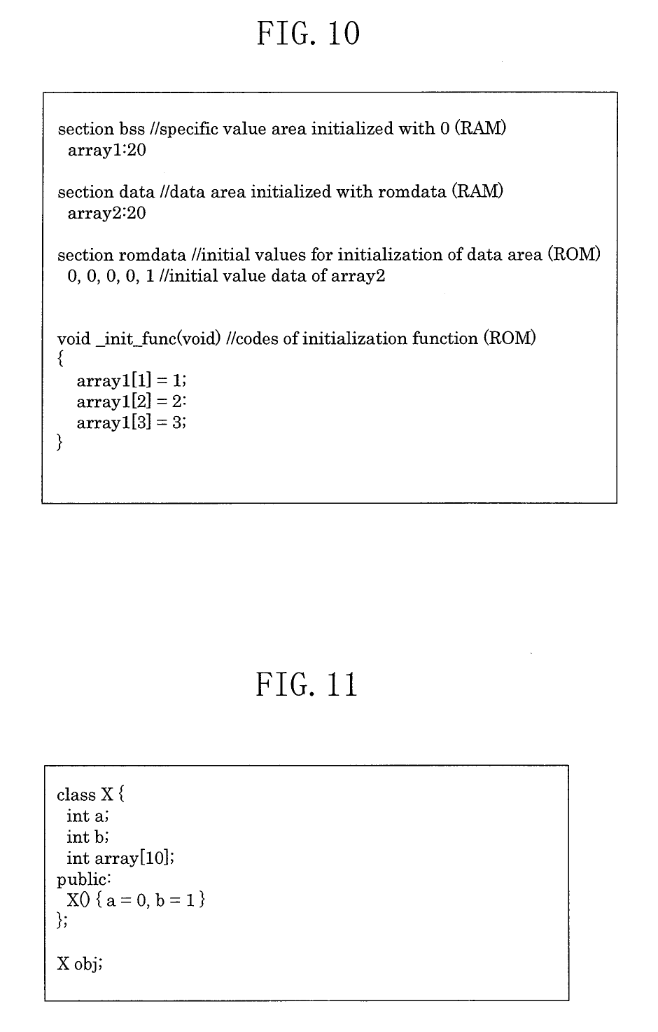

(1) The program converting device of this embodiment may further comprises a place-of-variable designation receiving unit (reception unit) (not shown) for receiving a programmer's designation about whether or not a variable is to be placed in the specific value area. For example, a variable described as “#pragma_position_bss variable name” may be recognized in a source program, and the variable may be determined to be placed in the specific value area. Also, a variable described as “#pragma_position_no_bss variable name” may be recognized, and the variable may be determined not to be placed in the specific value area. Also, an option “-mposition-bss-diffvalue-num=N” may be recognized, and a variable having some initial values different from the specific value the number of which is less than N may be placed in the specific value area. As a specific example, a conceptual diagram of an object file that is obtained by converting a source program shown in FIG. 9 in which a place-of-variable designation is described by #pragma, is shown in FIG. 10.

(2) As the format of an object file in this embodiment, the Executable and Linkable Format (ELF) may be employed, assuming that the specific value is 0 and the specific value area is the .bss section. Thereby, an embodiment of the present invention can be achieved using a standard object format.

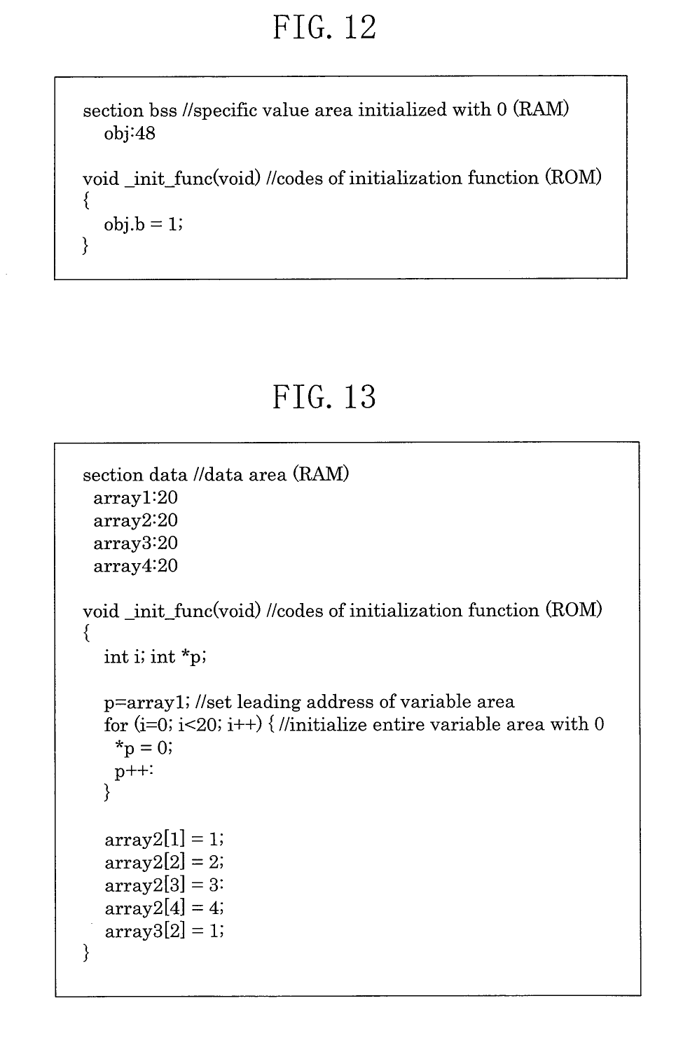

(3) The program converting device of this embodiment may further comprise an initial-value-of-variable calculating unit (not shown) for calculating an initial value of a variable when the initial value is not an immediate. A method for calculating an initial value with respect to a variable whose initial value is not represented by an immediate, in a source program, is well known (see, for example, Japanese Unexamined Patent Application Publication No. 2000-40005). Thereby, it is also possible to reduce a code size for initialization, with respect to a variable whose initialization is performed using an initialization function in the C++ language or the like (the initialization function is a constructor in the C++ language). As a specific example, a conceptual diagram of an object file obtained by converting a source program shown in FIG. 11 is shown in FIG. 12.

(4) The process of this embodiment may be implemented as software. The software may be distributed by downloading or the like. The software may also be recorded in a recording medium, such as a CD-ROM or the like, which may be in turn distributed.

The present invention is not limited to the aforementioned embodiments. Various modifications and variations can be made within the scope of the present invention.

What is claimed is:

1. A program converting device for converting an input source program to output an object program, comprising:
a recognition unit for recognizing variables and initial values of the variables included in the source program; and
a specific-value-area variable placing unit for placing the variables recognized by the recognition unit in specific value areas that are each initialized with a specific value before execution of the program, and when a value other than the specific value is included in the initial values of the variables, generating an initialization code with respect to the initial value other than the specific value.

2. The program converting device of claim 1, further comprising:
a place determining unit for calculating a cost when each of the variables recognized by the recognition unit is placed in a data area that is initialized with initialization data, and a cost when the each of the variables recognized by the recognition unit is placed in a specific value area that is initialized with a specific value, and depending on a result of the calculation, determining whether the each of the variables is to be placed in the data area or the specific value area.

3. The program converting device of claim 2, wherein
the cost is a code size.

4. The program converting device of claim 2, wherein
the cost is an execution time required to initialize the variables.

5. The program converting device of claim 1, further comprising:
a reception unit for receiving a user's designation about whether or not a variable including a value other than the specific value is to be placed in the specific value area.

6. The program converting device of claim 1, wherein
the specific value is 0.

7. The program converting device of claim 1, further comprising:
an initial-value-of-variable calculating unit for calculating an initial value of a variable when the initial value of the variable is not an immediate.
